(19) United States
(12) Patent Application Publication
(10) Pub. No.: US 2014/0084112 A1
(43) Pub. Date: Mar. 27, 2014

(54) BALLOON FASTENER

(71) Applicant: OSHN ARMOUR, LLC., Homestead, FL (US)

(72) Inventors: Hermann J. Stubbe, Miramar, FL (US); Christian Pereira, Homestead, FL (US)

(73) Assignee: Oshn Armour, LLC., Homestead, FL (US)

(21) Appl. No.: 13/626,153

(22) Filed: Sep. 25, 2012

(51) Int. Cl. B64C 31/06; B64B 1/40

(52) U.S. Cl. 244/155 R

(57) ABSTRACT

A balloon retainer for securing an inflated balloon having an inflation neck to a kite is provided. The balloon retainer includes a fabric element having three attachment points for securing the inflated balloon to the kite. The fabric element forms a pocket dimensioned to retain the inflated balloon. The balloon retainer also includes a balloon inflation neck securing mechanism configured to retain a portion of the inflation neck of the balloon.

### CROSS-REFERENCE TO RELATED APPLICATION

n/a

STATEMENT REGARDING FEDERALLY SPONSORED RESEARCH OR DEVELOPMENT

n/a

### FIELD OF THE INVENTION

The present invention relates to a method and system for attaching a balloon to a kite.

### BACKGROUND

Kite fishing is a fishing modality used in both recreational and commercial fishing. Kite fishing provides fishermen on shore the ability to fish in areas that are far from the shore and would otherwise be available with a boat. Similarly, for fishermen in boats, kite fishing provides a way to fish in areas that are not accessible by boat or that are too shallow for navigation. Kite fishing allows suspension of the bait right on top of the water at a fair distance from a boat or shore.

In kite fishing, a helium-filled balloon is secured to a kite usually using strings and tape. The balloon helps maintain the kite aloft and a line attached to the kite allows a fisherman to control the kite. One or more fishing lines are connected to the line of the kite using a releasable mechanism, such as a clip. On one end, each fishing line is attached to a rod and reel, and at the other end, the fishing line is attached to a bait holder that holds bait. When a fish bites and pulls on the bait, the releasable clip releases the fishing line. The fishing line is then reeled using the rod and reel.

Even though kite fishing has been around for many years, there has been little innovation with respect to methods of attaching a balloon to a kite. In fact, tying the balloon to the kite with strings and tape is the most common way of doing so. The strings are taped to the balloon and then attached to the kite. Once the balloon is attached, if there is a need to readjust the balloon, the tape needs to be removed, which often causes the balloon to pop. Given the disadvantages of using tape, most fishermen just use the strings to attach the balloon to the kite. However, attaching the balloon to the kite using strings is laborious. Thin strings are difficult to maneuver, especially during windy conditions, as the strings can become tangled.

### SUMMARY

A method and system for attaching a balloon to a kite is disclosed. In accordance with one aspect, a balloon retainer for securing a balloon having an inflation neck to a kite is provided. The balloon retainer includes a fabric element having three attachment points for securing the inflated balloon to the kite. The fabric element forms a pocket dimensioned to retain the inflated balloon. The balloon retainer also includes a balloon inflation neck securing mechanism configured to retain a portion of the inflation neck of the balloon.

In accordance with another aspect, the present invention provides a method for securing an inflated balloon having an inflation neck to a kite using a balloon retainer. The method includes attaching the balloon retainer to the kite. The balloon retainer includes a fabric element having three attachment points for securing the inflated balloon to the kite. The fabric element forms a pocket dimensioned to retain the inflated balloon. The method further includes securing a portion of the inflation neck to the fabric element using a balloon inflation neck securing mechanism configured to retain the portion of the inflation neck of the balloon.

According to another aspect, the invention provides a fishing rig. The fishing rig includes an inflated balloon, a kite, and a balloon retainer for retaining the inflated balloon to the kite. The balloon retainer includes a fabric element having three attachment points for securing the inflated balloon to the kite. The fabric element forms a pocket dimensioned to retain the inflated balloon. The balloon retainer further includes a balloon inflation neck securing mechanism configured to retain a portion of the inflation neck of the balloon.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a fishing rig constructed in accordance with the principles of the present invention;

FIG. 2 illustrates an exemplary balloon retainer securing an inflated balloon to a kite in accordance with the principles of the present invention;

FIG. 3 depicts an exemplary kite in accordance with the principles of the present invention;

FIG. 4A illustrates an exemplary balloon retainer securing an inflated balloon to a kite in a first configuration in accordance with the principles of the present invention;

FIG. 4B is an illustration of a side view of the balloon retainer of FIG. 4A in accordance with the principles of the present invention;

FIG. 5 depicts an exemplary balloon retainer securing an inflated balloon to a kite in a second configuration in accordance with the principles of the present invention;

FIG. 6 illustrates an exemplary balloon retainer securing an inflated balloon to a kite in a third configuration in accordance with the principles of the present invention;

FIG. 7 depicts a fishing rig including two kites in accordance with the principles of the present invention; and

FIG. 8 illustrates an exemplary balloon retainer including fastening elements in accordance with the principles of the present invention.

### DETAILED DESCRIPTION OF THE INVENTION

Embodiments of the present invention provide a method and system for securing a balloon to a fishing kite using a balloon retainer. The balloon retainer comprises a fabric element having three attachment points for securing the inflated balloon to three locations on the fishing kite. The balloon retainer is attached to the kite. The fabric element of the balloon retainer forms a pocket dimensioned to retain the balloon when inflated. A portion of the inflation neck is secured to the fabric element using a balloon inflation neck securing mechanism configured to retain the portion of the inflation neck of the balloon.

As used herein, relational terms, such as “first” and “second,” “top” and “bottom,” and the like, may be used solely to distinguish one entity or element from another entity or element without necessarily requiring or implying any physical or logical relationship or order between such entities or elements.

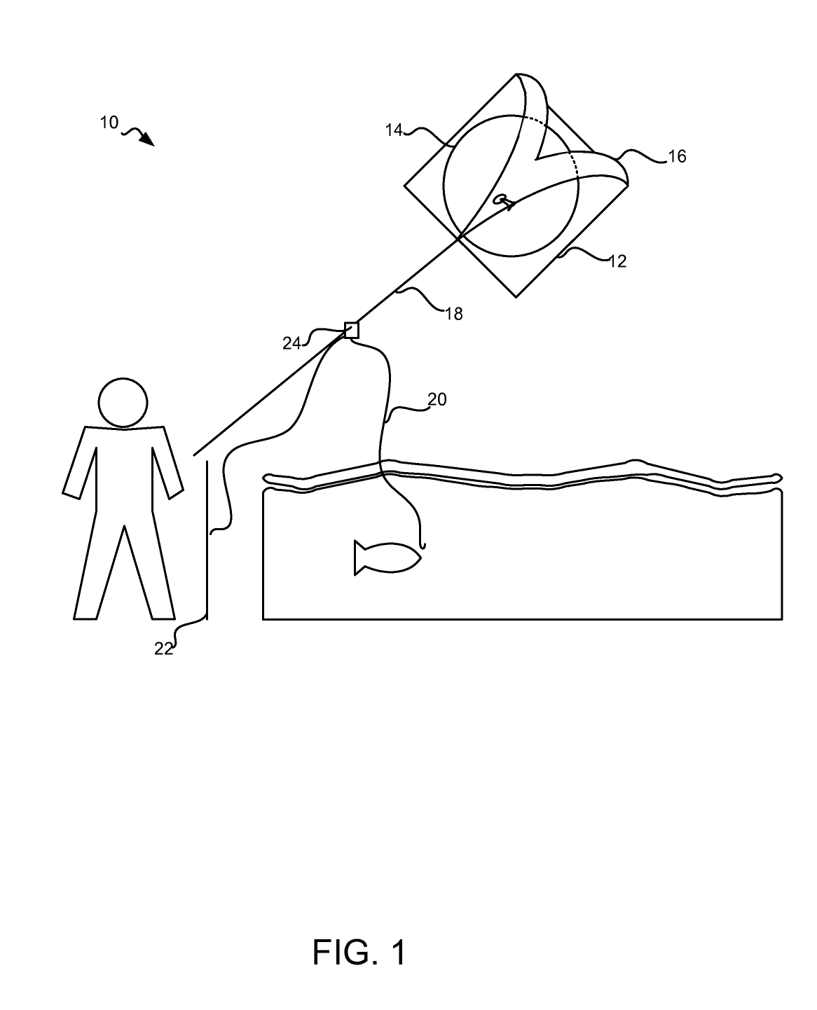

Referring now to the drawing figures in which reference designators refer to like elements, there is shown in FIG. 1 a schematic illustration of a fishing rig in accordance with the principles of the present invention, and generally designated as “10.” As shown in FIG. 1, fishing rig 10 includes a kite 12, a balloon 14 and a balloon retainer 16. The exemplary kite 12 has a substantially squared shape and includes a flying line 18. A fisherman flying the kite 12 can hold one end of the flying line 18 when the kite 12 is flying in the air. The fisherman can be fishing from, for example, the shore or a boat. A fishing line 20 proceeding from a fishing rod 22 is attached to the line 18 of the kite 12. The fishing rod 22 includes a reel used to adjust the fishing line 20.

A releasable clip 24 can be used to releasably secure the fishing line 20 to the line 18 of the kite 12. The releasable clip 24 is releasably attached to the flying line 18, so that when a fish bites and pulls on the fishing line 20, the releasable clip 24 releases from the flying line 18 and drops to the water. Although FIG. 1 shows a single fishing rig 10, the invention is not limited to such, as any number of fishing rigs 10 may be used.

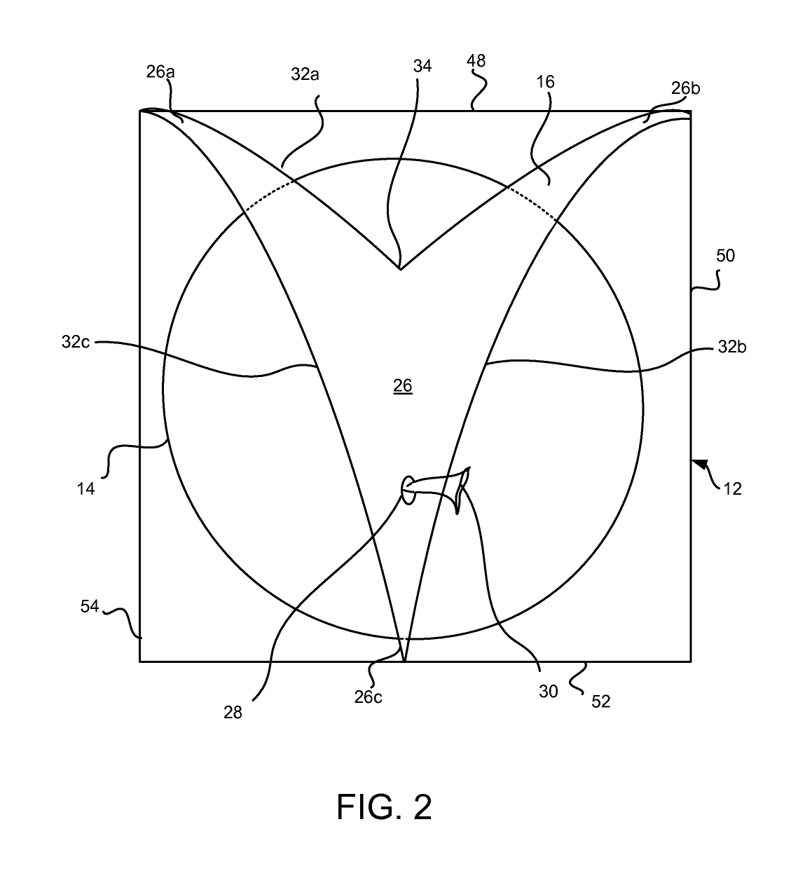

FIG. 2 depicts an exemplary balloon retainer 16 attached to the kite 12. The balloon retainer 16 may allow the balloon 14 to be easily attached to the kite 12. The balloon retainer 16 may be made of a solid piece of fabric, plastic, mesh fabric, synthetic material, weave, cloth, paper, or any other suitable material. The balloon retainer 16 can be constructed from any material that allows the balloon retainer 16 to be folded to fit in a small pocket of a fishing jacket. In this exemplary embodiment, the balloon retainer 16 includes a fabric element 26. The fabric element 26 includes three attachment points 26a, 26b and 26c used for securing the balloon retainer 16 to the kite 12 when the balloon 14 is inflated. Attachment points 26a, 26b and 26c attach to the kite 12, allowing the fabric element 26 to form a pocket dimensioned to retain the inflated balloon 14 to the kite 12.

As the balloon 14 is inflated, the balloon 14 pushes the balloon retainer 16 away from the kite 12, creating a pocket with the kite 12. The balloon 14 can be retained inside the formed pocket. The size of the balloon retainer 16 varies depending on the size of the balloon 14 when inflated. The size of the balloon retainer 16 may also vary depending on the size of the kite 12. The balloon retainer 16 further includes a balloon inflation neck securing mechanism 28 configured to retain a portion of an inflation neck 30 of the balloon 14. The Balloon inflation neck securing mechanism 28 can be an aperture provided through the fabric element 26. The aperture may be dimensioned to receive and retain a portion of the inflation neck 30 of the balloon 14. For example, a portion of the inflation neck 30 of the balloon 14 may be inserted through the aperture of the fabric element 26. The portion of the inflation neck 30 may be inserted through the aperture when the balloon 14 is inflated or deflated.

The aperture in the fabric element 26 may be constructed to specifically allow a portion of the inflation neck 30 to fit tightly inside the aperture, i.e., the aperture may allow a portion of the inflation neck 30 to fit snuggly in the aperture. A knot may be tied in the inflation neck 30. The size of the knot may be larger than the aperture so that the knot is not pulled back through the aperture. The knot and the aperture may cause the balloon 14 to remain secured to the balloon retainer 16.

The balloon inflation neck securing mechanism 28 may be any type of securing mechanism. For example, instead of an aperture, the inflation neck securing mechanism 28 may be a rubber band attached to the fabric element 26. The rubber band may be used to hold a portion of the inflation neck 30 to the balloon retainer 16. The balloon inflation neck securing mechanism 28 may also be a clip, a hook, a loop, a clamp, a snap, a clasp, a string, a pin, or any fastening device that may be used to attach the balloon 14 to the balloon retainer 16.

To inflate the balloon 14, the balloon inflation neck 30 can be inserted into the balloon inflation neck securing mechanism 28. The balloon 14 can be inflated while the balloon inflation neck 30 is secured by the balloon inflation neck securing mechanism 28 to the fabric element 26 and hence, to the kite 12. The inflation neck 30 of the balloon 14 may be inserted through the balloon inflation neck securing mechanism 28 to inflate the balloon 14 with, for example, an air or helium pump connected to the inflation neck 30. As the balloon 14 gets filled up with air, the balloon 14 expands, pushing the balloon retainer 16 to form a pocket dimensioned to retain and embrace the inflated balloon 14. While the balloon 14 is being filled with gas, the balloon retainer 16 can hold the balloon 14 and prevent the balloon 14 from moving away from the kite 12.

The balloon 14 can be filled with gas until the balloon 14 expands to a size where the balloon 14 can fit snuggly between the balloon retainer 16 and the kite 12. For example, the balloon 14 may be filled with gas until the inflated balloon 14 reaches a size where the inflated balloon 14 pushes the balloon retainer 16, which is attached to the kite 12, as far as possible from the kite 12. The balloon retainer 16 may stretch until the balloon retainer 16 is tense enough to secure the inflated balloon 14 firmly to the kite 12. Using the balloon retainer 16 to attach the balloon 14 to the kite 12 may be easier than using strings to secure the balloon 14 to the kite 12.

In an exemplary embodiment, the attachment points 26a, 26b and 26c are securable to the kite 12 in a spaced-apart relationship. The attachment points 26a, 26b and 26c can be secured anywhere on the kite 12. The three attachment points 26a, 26b and 26c can be secured to three different locations along a periphery of the kite 12. Further, the kite 12 may include a first side 48, a second side 50 adjacent/connected to the first side 48, a third side 52 adjacent/connected to the second side 50 and opposite to the first side 48, and a fourth side 54 adjacent/connected to the third side 52 and opposite to the second side 50.

For instance, the attachment points 26a, 26b and 26c may be secured to two of four sides of the kite 12 such as the first side 48 and the third side 52 of the kite 12, and the two sides of the kite 12 may be opposing. One of the three attachment points 26a, 26b and 26c can be secured to one side of four sides of the kite 12, such as the third side 52, and two of the three attachment points 26a, 26b and 26c can be secured to the side opposite the one side, e.g., the attachment points 26a and 26b can be attached to the first side 48.

The fabric element 26 includes a plurality of fabric element sides 32a, 32b and 32c that connect the three attachment points 26a, 26b and 26c. One of the fabric element sides 32a, 32b and 32c may have a notch 34. The notch 34 may be dimensioned to impart a substantially “Y” shape to the fabric element 26. The balloon retainer 16 may have any shape, such as a T shape, a triangular shape, etc. The balloon inflation neck securing mechanism 28, which may be an aperture in the fabric element 26, may be proximate one of the attachment points 26a, 26b and 26c. For example, the balloon inflation neck securing mechanism 28 may be proximate attachment point 26c, and that attachment point 26c may be opposite fabric element side 32a that includes the notch 34. The balloon retainer 16 may be fastened to the kite 12 by securing the attachment points 26a, 26b and 26c to the kite 12 using a fastening element.

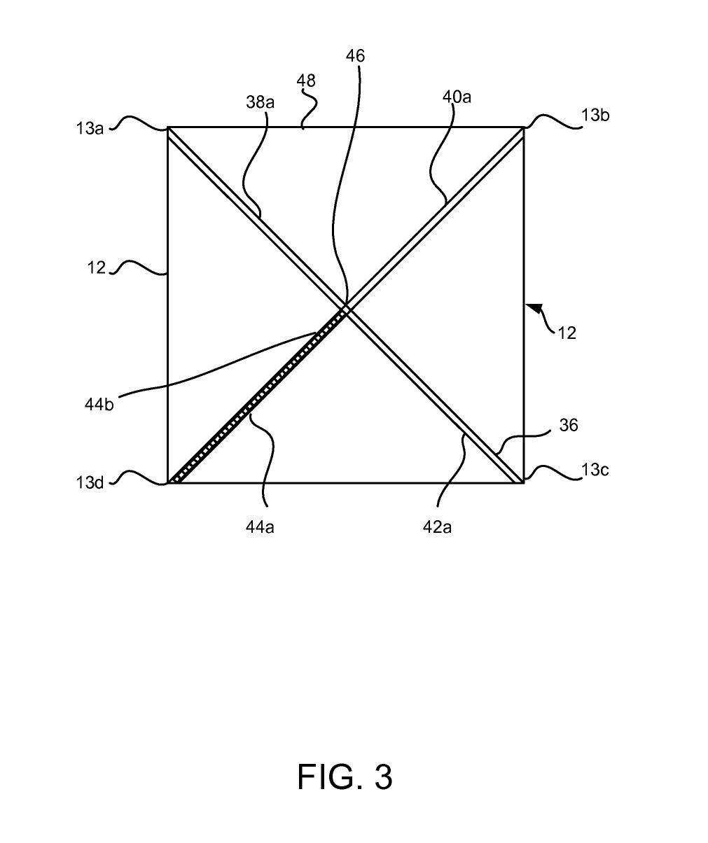

FIG. 3 is an illustration of the exemplary kite 12. The kite 12 may include a frame 36. The frame 36 may include four frame portions: a first frame portion 38a, a second frame portion 40a, a third frame portion 42a and a fourth frame portion 44a. Each frame portion, i.e., the first frame portion 38a, the second frame portion 40a, the third frame portion 42a, and the fourth frame portion 44a, includes multiple frame locations where the balloon retainer 16 may be secured to. For example, the fourth frame portion 44a includes multiple locations, where a fourth frame location 44b is one of the multiple locations on the fourth frame portion 44a. Although not shown in FIG. 3, the first frame portion 38a, the second frame portion 40a and the third frame portion 42a also include multiple locations where the balloon retainer 16 may be secured to.

The frame 36 may have a substantially “X” configuration, where the middle of the “X” corresponds to a middle 46 of the frame 36. The cover or sail of the kite 12 may be made of paper, plastic and cloth, among other materials. The exemplary kite 12 has an approximate squared shape including a first corner 13a, a second corner 13b, a third corner 13c and a fourth corner 13d.

The first and second corners 13a and 13b may be connected by the first side 48 of the kite 12. The second and third corners 13b and 13c may be connected by the second side 50 of the kite 12. The third and fourth corners 13c and 13d may be connected by the third side 52, and the fourth and first corners 13d and 13a may be connected by the fourth side 54 of the kite 12. The attachment points 26a, 26b and 26c can be attached anywhere on the kite 12, including any corner of the kite 12. For example, the attachment point 26a may be attached to the first corner 13a, the attachment 26b may be attached to the second corner 13b and the attachment 26c may be attached to the middle 46, to third corner 13c and/or the fourth corner 13d. In fact, the attachment points 26a, 26b and 26c may be attached anywhere on the kite 12 and/or the frame 36, such as the first frame portion 38a, the second frame portion 40a, the third frame portion 42a and the fourth frame portion 44a.

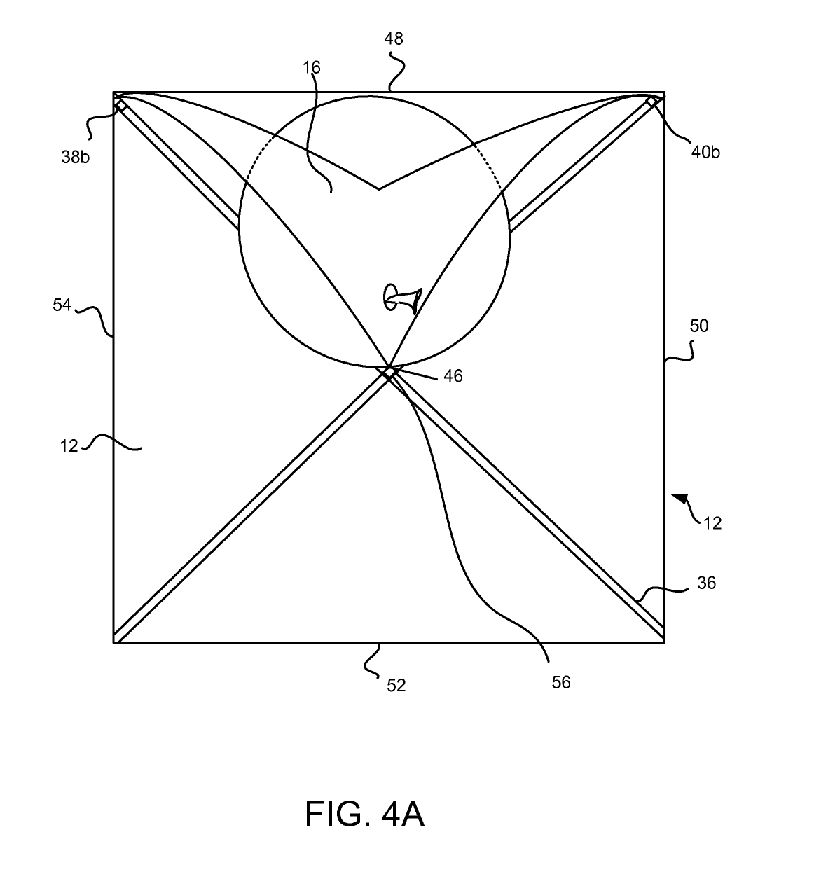

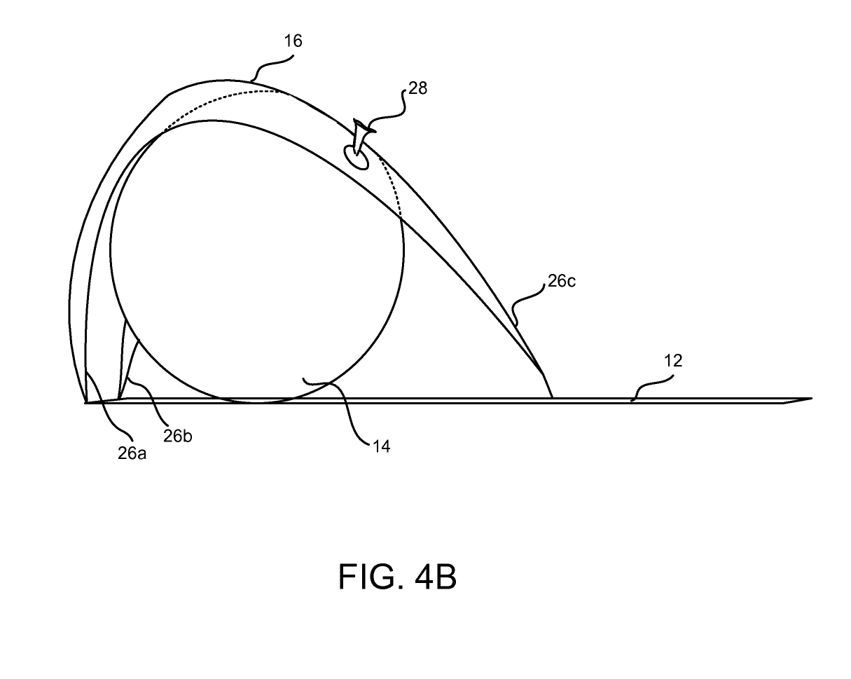

FIG. 4A depicts the balloon retainer 16 attached to the frame 36 of the kite 12. FIG. 4A shows another configuration where the attachment points 26a, 26b and 26c are attached to the frame 36. The first frame portion 38a may include a first frame location 38b. The first frame location 38b may be any location on the first frame portion 38a. The attachment point 26a may be attached to the first frame location 38b, which may be proximate to a side of the kite 12, such as the first side 48. The second frame portion 40a may include a second frame location 40b. The second frame location 40b may be any location on the second frame portion 40a. The attachment point 26b may be attached to the second frame location 40b, which may be proximate to the same side of the kite, e.g., the first side 48.

A third frame location 56 may be in the middle 46 of the frame 36 or may be proximate to the middle 46 of the frame 36. The attachment point 26c may be secured to the third frame location 56. This configuration may result in the kite 12 flying in an approximate straight pattern, as the inflated balloon 14 would be mostly centered on the top part of the kite 12. When flying a single kite 12, this configuration may allow the kite 12 to fly mostly parallel to the direction the wind is blowing. As another example, the attachment points 26a and 26b may be attached to the first side 48 and the attachment point 26c may be attached to the second side 50, the third side 52, the fourth side 54 or the middle 46 of the kite 12.

FIG. 4B is an illustration of a side view of FIG. 4A. As seen on FIG. 4A, the inflated balloon 14 pushes the balloon retainer 16 away from the kite 12, and the balloon retainer 16 forms a pocket with the kite 12 dimensioned to retain the inflated balloon 14. The attachment point 26a is attached to the first frame location 38b, the attachment point 26b is attached to the second frame location 40b and the attachment point 26c is attached to the third frame location 56, i.e. approximately in the middle 46 of the kite 12.

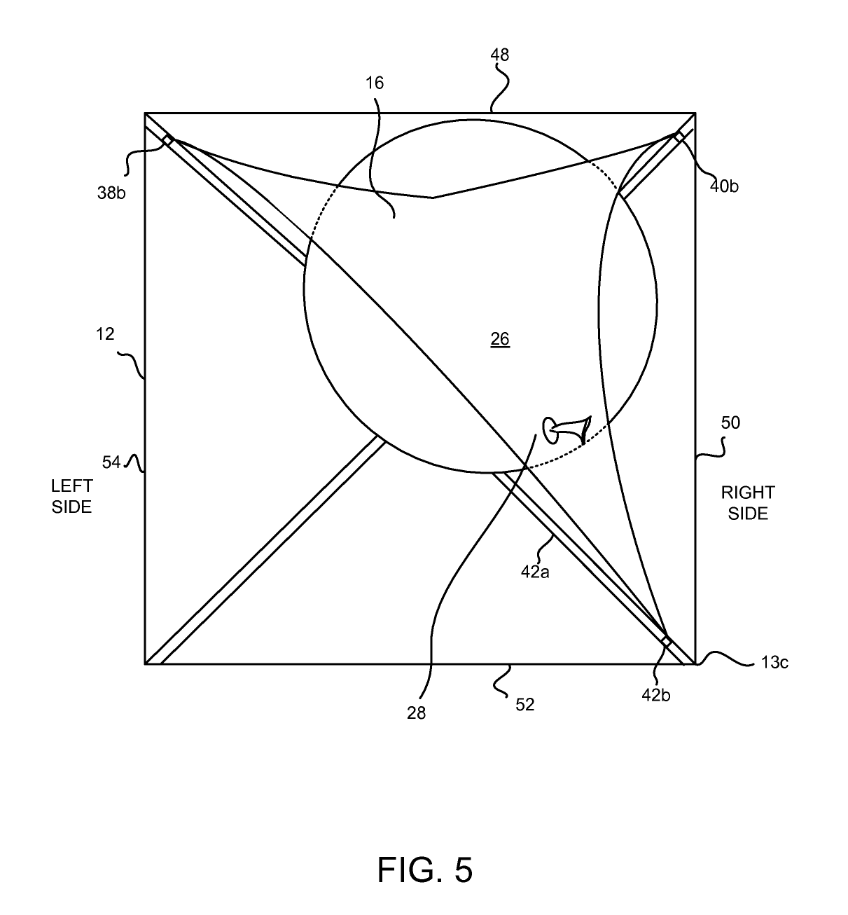

FIG. 5 depicts the exemplary balloon retainer 16 attached to the frame 36 of the kite 12 in another configuration. Similar to the configuration shown in FIG. 4A, the attachment points 26a, 26b and 26c may be secured to three portions of the frame 36. The attachment point 26a can be secured to the first frame location 38b, the attachment point 26b can be secured to the second frame location 40b, and the attachment point 26c may be secured to a fourth frame location 42b. The fourth frame location 42b may any location on the third frame portion 42a.

In this example, the fourth frame location 42b on the third frame portion 42a is proximate to the second side 50 and the third side 52 of the kite 12, i.e., proximate to the corner 13c. By securing the attachment point 26c close to the corner 13c of the kite 12, the balloon retainer 16 pushes the balloon 14 toward the second side 50 of the kite 12. Securing the attachment point 26c to the fourth frame location 42b, may cause the balloon 14 to be retained to the right side of the kite 12, which may make the kite 12 fly slightly towards the right. Since the balloon 14 is closer to the second side 50 than to the fourth side 54, more of the left side of the kite 12, i.e., the surface area proximate to the fourth side 54 is exposed to the wind/air. As the wind hits the left side of the kite 12, the wind pushes the kite 12 toward the right. This configuration may cause the kite 12 to fly straight and slightly towards the right.

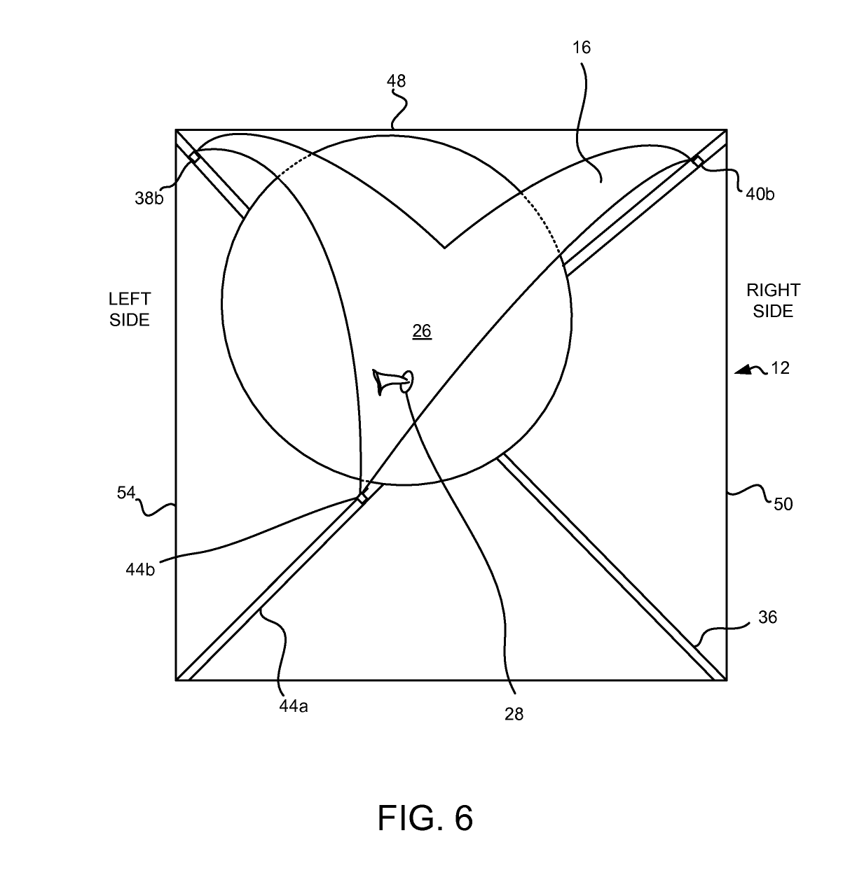

FIG. 6 is an illustration of the exemplary balloon retainer 16 attached to the frame 36 of the kite 12 in another configuration. The attachment point 26a can be secured to the first frame location 38b, the attachment point 26b can be secured to the second frame location 40b, and the attachment point 26c may be secured to the fifth frame location 44b. The fifth frame location 44b may be any location on the fourth frame portion 44a. Securing the attachment point 26c to the fifth frame location 44b may result in the kite 12 flying straight with the wind and slightly towards the left. The balloon 14 is retained by the balloon retainer 16 to the left side of the kite 12, exposing more of the kite's 12 surface area on the right, i.e., the surface area proximate to the second side 50. The wind against the exposed surface area of the kite 12 causes the kite 12 to fly straight and slightly towards the left. This configuration may be desirable when two kites 12 are flown at the same time. For example, one kite 12 may be flown using the configuration described in FIG. 5 and another kite 12 may be flown using the configuration described in FIG. 6.

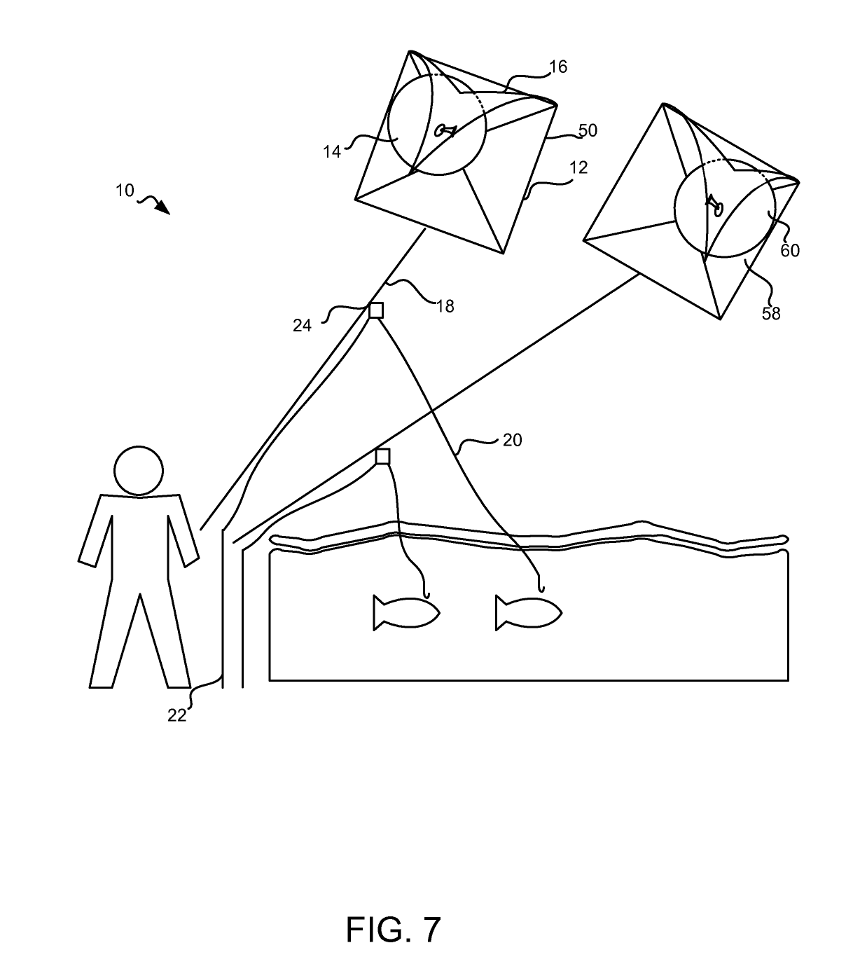

FIG. 7 illustrates two exemplary kites flown together, the exemplary kite 12 and an exemplary kite 58. The balloon 14 is secured to the kite 12 using the configuration described in FIG. 6, i.e., the balloon 14 is retained to the left side of the kite 12. The surface area proximate to the side 54 is exposed to the wind. A balloon 60 on the kite 58 is secured to the right of the kite 58, i.e., similar to the configuration shown in FIG. 5. Due to how the balloon 14 is retained to the kite 12, the kite 12 does not fly completely straight, but slightly towards the left. Similarly, due to how the balloon 60 is retained to the kite 58, the kite 58 flies slightly towards the right. Arranging the balloon 14 towards the left side of the kite 12 and the balloon 60 towards the right side of the kite 58 may prevent the kites 12 and 58 from flying straight and hence, colliding with each other.

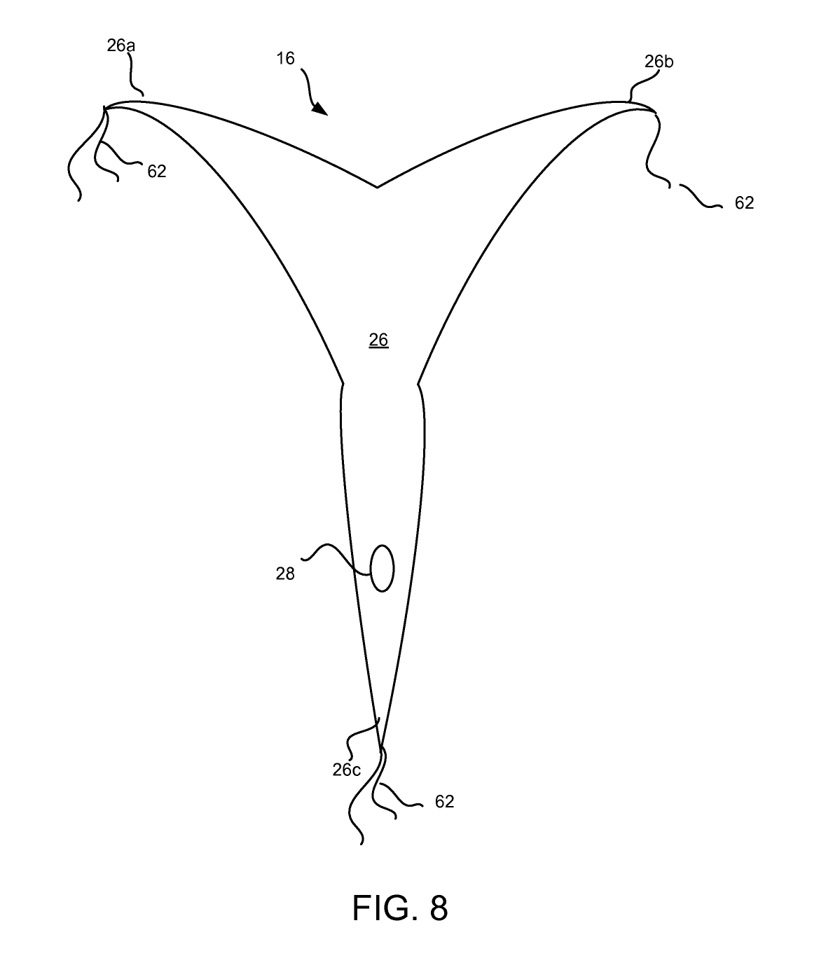

FIG. 8 depicts another exemplary balloon retainer 16. The balloon retainer 16 includes the attachment points 26a, 26b and 26c. The fabric element 26 of the balloon retainer 16 may be of any shape, such as the narrow shape shown in FIG. 8. The balloon retainer 16 may include a plurality of fastening elements 62, wherein each fastening element 62 secures one of the attachment points 26a, 26b and 26c to the kite 12. The fastening elements 62 may be strings, buttons, clasps, rivets, hocks, snaps, or any other type of fastening element.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

What is claimed is:

1. A balloon retainer for securing an inflated balloon having an inflation neck to a kite, the balloon retainer comprising:
a fabric element having three attachment points for securing the inflated balloon to the kite, wherein the fabric element forms a pocket dimensioned to retain the inflated balloon; and
a balloon inflation neck securing mechanism, the balloon inflation neck securing mechanism configured to retain a portion of the inflation neck of the balloon.

2. The balloon retainer of claim 1, wherein each attachment point is securable to the kite in a spaced-apart relationship, and wherein the balloon inflation neck securing mechanism is an aperture provided through the fabric element, the aperture being dimensioned to receive and retain the portion of the inflation neck of the balloon.

3. The balloon retainer of claim 2, wherein the three attachment points are secured to three different locations along a periphery of the kite, one of the three attachment points is secured to one side of four sides of the kite, and two of the three attachment points are secured to the side opposite the one side.

4. The balloon retainer of claim 2, wherein the kite includes a frame having a first frame location proximate to a side of the kite, a second frame location proximate to the side of the kite and a third frame location proximate to the middle of the frame, and wherein the three attachment points comprise a first attachment point, a second attachment point and a third attachment point, and wherein the first attachment point is secured to the first frame location, the second attachment point is secured to the second frame location, and the third attachment point is secured to the third frame location.

5. The balloon retainer of claim 2, wherein the kite has an approximate squared shape including a middle, a first corner and a second corner, the first and second corners connected by a first side of the kite, and wherein the three attachment points are secured to the first corner, the second corner and the middle.

6. The balloon retainer of claim 2, wherein the kite has an approximate squared shape including a first corner, a second corner and a third corner, the first and second corners connected by a first side of the kite, the second and third corners connected by a second side of the kite adjacent to the first side, and the three attachment points are secured to the first, second and third corners.

7. The balloon retainer of claim 2, wherein the kite includes a frame having a first frame location proximate to a first side of the kite, a second frame location proximate to the first side of the kite and a third frame location proximate to a second side of the kite connected to the first side, and wherein the three attachment points comprise a first attachment point, a second attachment point and a third attachment point, and wherein the first attachment point is secured to the first frame location, the second attachment point is secured to the second frame location, and the third attachment point is secured to the third frame location.

8. The balloon retainer of claim 4, wherein the fabric element includes a plurality of sides that connect the three attachment points, one of the sides having a notch, and wherein the aperture is proximate one of the attachment points, and that attachment point is opposite a side of the retaining element that includes the notch.

9. The balloon retainer of claim 8, wherein the notch is dimensioned to impart a substantially “Y” shape to the fabric element.

10. The balloon retainer of claim 9, further comprising a plurality of fastening elements, wherein each fastening element of the plurality of fastening elements secures one of the attachment points to the kite.

11. The balloon retainer of claim 9, wherein the fabric element is one of a solid piece of fabric and a mesh fabric.

12. A method for securing an inflated balloon having an inflation neck to a kite using a balloon retainer, the method comprising:
attaching the balloon retainer to the kite, the balloon retainer comprising a fabric element having three attachment points for securing the inflated balloon to the kite, wherein the fabric element forms a pocket dimensioned to retain the inflated balloon; and
securing a portion of the inflation neck to the fabric element using a balloon inflation neck securing mechanism configured to retain the portion of the inflation neck of the balloon.

13. The method of claim 12, wherein each attachment point is securable to the kite in a spaced-apart relationship, and wherein the balloon inflation neck securing mechanism is an aperture provided through the fabric element, the aperture being dimensioned to receive and retain the portion of the inflation neck of the balloon.

14. The method of claim 13, further comprising:
securing the three attachment points to three different locations along a periphery of the kite, wherein securing includes:
securing one of the three attachment points to one side of the two sides of the kite; and
securing two of the three attachment points to the side opposite the one side.

15. The method of claim 13, wherein the kite includes a frame having a first frame location proximate to a side of the kite, a second frame location proximate to the side of the kite and a third frame location proximate to the middle of the frame, and wherein the three attachment points comprise a first attachment point, a second attachment point and a third attachment point, the method further comprising:
securing the first attachment point to the first frame location;
securing the second attachment point to the second frame location; and
securing the third attachment point to the third frame location.

16. The method of claim 13, wherein the kite has an approximate squared shape including a middle, a first corner and a second corner, the first and second corners connected by a first side of the kite, the method further comprising:
securing the three attachment points to the first corner, the second corner and the middle.

17. The method of claim 13, wherein the kite has an approximate squared shape including a first corner, a second corner and a third corner, the first and second corners connected by a first side of the kite, the second and third corners connected by a second side of the kite adjacent to the first side, the method further comprising:
securing the three attachment points to the first, second and third corners.

18. The method of claim 13, wherein the kite includes a frame having a first frame location proximate to a first side of the kite, a second frame location proximate to the first side of the kite and a third frame location proximate to a second side of the kite connected to the first side, and wherein the three attachment points comprise a first attachment point, a second attachment point and a third attachment point, the method further comprising:
securing the first attachment point to the first frame location;
securing the second attachment point to the second frame location; and
securing the third attachment point to the third frame location.

19. The method of claim 18, wherein the fabric element includes a plurality of sides that connect the three attachment points, one of the sides having a notch dimensioned to impart a substantially “Y” shape to the fabric element, and wherein the aperture is proximate one of the attachment points, and that attachment point is opposite a side of the retaining element that includes the notch.

20. A fishing rig comprising:
an inflated balloon;
a kite; and
a balloon retainer for retaining the inflated balloon to the kite, the balloon retainer comprising:
a fabric element having three attachment points for securing the inflated balloon to the kite, wherein the fabric element forms a pocket dimensioned to retain the inflated balloon; and
a balloon inflation neck securing mechanism, the balloon inflation neck securing mechanism configured to retain a portion of the inflation neck of the balloon.
